(19) United States
(12) Patent Application Publication
(10) Pub. No.: US 2008/0120676 A1
(43) Pub. Date: May 22, 2008

(54) Integrated circuit, an encoder/decoder architecture, and a method for processing a media stream

(75) Inventors: Amir Morad, Tel-Aviv (IL); Leonid Yavits, Herzlia (IL); Gedalia Oxman, Tel-Aviv (IL); Ofer Austerlitz, Tel-Mond (IL); Michael Khrapkovsky, Herzlia (IL)

Correspondence Address: Martin D. Moynihan;PRTSI, Inc., P.O. Box 16446, Arlington, VA, 22215, US

(73) Assignee: Horizon Semiconductors Ltd., Herzlia (IL)

(21) Appl. No.: 11/603,199

(22) Filed: Nov. 22, 2006

(51) Int. Cl. H04N 7/173; H04N 5/00; H04N 11/02

(52) U.S. Cl. 725/127; 386/117; 375/240.01; 375/E07.076

(57) ABSTRACT

An integrated circuit for pre-processing, encoding, decoding, transcoding, indexing, blending, post-processing and display of media streams, in accordance with a variety of compression algorithms, DRM schemes and related industry standards and recommendations such as OCAP, ISMA, DLNA, MPAA etc. The integrated circuit comprises an input interface configured for receiving the media streams from content sources, a plurality of processing units, system CPU, and sophisticated switch and memory controller, electronically connected to the input interface and directly connected to each one of the processing units. The integrated circuit further comprises an output interface that is operatively connected to the switch and configured for outputting the simultaneously processed media streams.

### FIELD AND BACKGROUND OF THE INVENTION

The present invention relates to encoding and decoding hardware and, more particularly but not exclusively, to a system on chip (SoC) that comprises a number of processing units for allowing simultaneous processing of media streams or variants thereof.

During the last decade, service and content providers have encountered an increasing demand for high quality interactive video and audio content. This demand has led to the development of technologies that facilitate interactive video and collaborative video applications such as video conferencing and gaming. In most cases, the raw data requirements for such applications far exceed available bandwidth, such that data compression is necessary to meet the demand.

One of the significant components used in the process is the encoder/decoder (CODEC) module. The CODEC module is an electronic device that converts analog signals, such as video and voice signals, into digital form, blends them together, and usually compresses them to conserve bandwidth on a transmission path or storage, and vice versa. Moreover, CODEC modules may be used to decompress digital bitstreams into uncompressed streams, either digital or analog, for processing and displaying.

Using various compression algorithms, the CODEC modules decompress information such as compressed video and audio streams. The CODEC modules may also recompress the information using different compression algorithms. For example, one or more video, audio or still images already compressed using a certain compression algorithm are decompressed, blended, and then re-compressed using a different compression method or even the same compression method using different parameters such as different video resolution, etc. In such a mode, the CODEC module is used as a transcoder that allows the conversion of information, particularly audio and video, from one format to another.

Usually, CODEC modules consist of encoding and decoding paths. The encoding path usually consists of an acquisition device that is connected to a video encoding device, an audio encoding device, or a combination thereof. The encoding devices are connected to a multiplexing device that outputs a multiplexed data-stream that is composed of compressed & uncompressed time-stamped audio, video and data packets. The decoding path usually consists of a digital stream acquisition device, which is connected to a demultiplexing device that is in turn connected to a video decoding device, an audio decoding device, or a combination thereof. The video decoding device is connected to a video output, either directly or through a blender device, which is designed to blend a plurality of video and data channels together with graphics.

For example, U.S. Pat. No. 6,222,885, published Apr. 24, 2001, discloses a system for processing video and audio data that combines standard video, audio and memory components with a customized integrated circuit that performs programmable compression and decompression using a table-based hierarchical vector quantization algorithm. The system comprises a record path with a video decoder, that receives analog video input signals and generates a digitized video signal in a selected format, and an output path that comprises a video port that supplies the data to an external video encoder. The output of the video encoder drives the video display. The audio and video decoding devices may be respectively connected to audio and video outputs through an analog converter. Another drawback is hardware redundancy. Although there is an overlap between encoding and decoding tasks and between encryption and decryption tasks, different hardware components are used to perform these tasks. The hardware redundancy increases the size, the price and the power consumption of the CODEC module.

There is thus a widely recognized need for, and it would be highly advantageous to have, a compact and efficient CODEC module devoid of the above limitations.

### SUMMARY OF THE INVENTION

According to one aspect of the present invention there is provided an integrated circuit for processing a media stream, comprising:

an input interface configured for receiving said media stream from a content source;

a plurality of processing units;

a switch, electronically connected to said input interface and directly connected to each said processing unit, said switch configured for allowing two said processing units to simultaneously receive said media stream, thereby allowing simultaneous processing of said media stream by said processing units; and

an output interface, operatively connected to said switch, configured for outputting said simultaneously processed media stream.

According to a second aspect of the present invention there is provided a method for providing a media stream, comprising:

a) receiving said media stream from a content source;

b) simultaneously providing said media stream to a plurality of processing units by allowing communication between any two of said plurality of processing units; and

c) outputting said simultaneously processed media stream.

According to a third aspect of the present invention there is provided a home gateway for processing a media stream, comprising:

an input interface configured for receiving said media stream;

a plurality of tuners, electronically connected to said input interface, each one of said tuners being configured for a different channel of said media stream;

an encoding/decoding unit, electronically connected to said tuners, configured for simultaneously processing said different channels; and

an output interface, operatively connected to said encoding/decoding unit, configured for outputting said simultaneously processed different channels.

According to a fifth aspect of the present invention there is provided a camcorder having a processing unit for processing a captured media stream, said camcorder comprising:

at least one image sensor for capturing a sequence of images and generating a media stream based thereupon;

a plurality of processing units;

a switch, electronically connected to said at least one image sensor and directly connected to each said processing unit, said switch configured for allowing two said processing units to simultaneously receive said media stream, thereby allowing simultaneous processing of said media stream by said processing units; and

an output interface, operatively connected to said switch, configured for outputting said simultaneously processed media stream.

According to a sixth aspect of the present invention there is provided a digital television having an encoding/decoding unit, said digital television comprising:

a display unit;

a personal video recorder unit configured for generating a first media stream;

an input interface configured for receiving a second media stream;

a plurality of tuners, electronically connected to said input interface, each one of said tuners being configured for a different channel of said second media stream; and

an encoding/decoding unit, electronically connected to said tuners and to said personal video recorder, configured for simultaneously processing said different channels and said first and second media streams for outputting said simultaneously processed different channels to said display unit.

According to a seventh aspect of the present invention there is provided a method for enabling a media stream for use with video transport controls, the method comprising:

a) receiving said media stream from a content source;

b) tagging frames of said media stream, each said frame being tagged according to its characteristics;

c) receiving a command for a given transport control;

d) selecting frames according to corresponding tags, said selecting being determined by the given transport control; and

e) playing said selected frames.

Unless otherwise defined, all technical and scientific terms used herein have the same meaning as commonly understood by one of ordinary skill in the art to which this invention belongs. The materials, methods, and examples provided herein are illustrative only and are not intended to be limiting.

Implementation of the apparatus and method of the present invention involves performing or completing certain selected tasks or steps manually, automatically, or a combination thereof. Moreover, according to actual instrumentation and equipment of preferred embodiments of the apparatus and method of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the apparatus and method of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of an integrated circuit for processing one or more media streams, in accordance with one embodiment of the present invention;

FIG. 2 is a block diagram that depicts the relationship among electronic components of a media CODEC integrated circuit, in accordance with one embodiment of the present invention;

FIG. 3 is a block diagram that depicts the relationship among electronic components of a rate distortion optimization processor, in accordance with one embodiment of the present invention;

FIG. 4 is a block diagram that depicts the relationship among electronic components of a home gateway or a digital set top box with optional digital personal video recorder that comprises a media CODEC as depicted in FIG. 2, in accordance with one embodiment of the present invention;

FIG. 5 is a block diagram that depicts the relationship among electronic components of combined analog-digital home gateway or set top box with optional personal video recorder, in accordance with one embodiment of the present invention;

FIG. 6 is a block diagram that depicts the relationship among electronic components of a digital TV with digital terrestrial (advanced television systems committee) support and optional digital cable support and optional embedded personal video recorder, according to a preferred embodiment of the present invention; and

FIG. 7 is a simplified flowchart of an exemplary method for processing media streams, according to a preferred embodiment of the present invention.

### DESCRIPTION OF THE PREFERRED EMBODIMENTS

The present embodiments comprise an apparatus and a method for a multi-standard media compression and decompression unit that is used, inter alia, for processing signals from one or more sources.

One embodiment of the present invention is related to media signal compression in home gateways, set top boxes, DVD and HD-DVD recorders, personal video recorders, place-shift TV etc. One embodiment of the present invention discloses an electronic circuit that operates as a multi-standard media processor designed for encoding, decoding, and blending media streams using one or more compression and decompression algorithms. Different video compression and decompression algorithms, which are defined according to various standards, may be used. For example, standards such as the MPEG1 standard, the MPEG2 standard, the MPEG4 standard, the advanced video codecs such as AVC and VC-1, the Chinese compression system (AVS) and many others may be used. In addition, different audio compression and decompression algorithms, which are defined according to various standards, such as the Dolby digital (AC-3) standard, the advanced audio coding (AAC) standard, the MPEG-1 audio layer-3 (MP3) standard, the DTS audio compression etc., may also be used for processing audio signals. In addition, different still image compression and decompression algorithms, such as JPEG, GIF, PNG, MNG etc. may also be used for processing of still images, In addition different data streams standards are processed, such as Electronic Program Guide (EPG), Graphics, HTML etc., and various peripherals are supported such as Ethernet, hard-disk, USB etc.

The video compression may remove spatial redundancy of video signals and therefore may include different processes such as a quantization process and a spatial transformation process. Spatial transformation processes may be used to convert media signals in a spatial domain into signals in another domain, for example, the frequency domain. Quantization may be applied for converting a high-precision digital signal into a lower-accuracy digital signal by assigning fewer bits in the binary representation of such a digital signal. The output of this process is a stream of quantized video coefficients.

In order to increase the efficiency of the compression and the visual quality of compressed media, media signals are preferably preprocessed before being compressed by the multistandard media processor. Preprocessing may include one or more of the following: down-scaling or up-scaling of the video signals, spatial filtering, temporal filtering, linear filtering, nonlinear filtering, noise reduction, etc.

As a final stage of a compression process, an entropy encoder may be used to remove further redundancy by minimizing the signal entropy. The entropy encoding improves efficiency of the compression process.

Preferably, as further described below, the compressed digital video signals may be decoded by an entropy decoder in order to restore a stream of quantized video coefficients.

Removing temporal redundancy may also be used to enhance the compression process. For example, a motion estimation processor may be used to analyze the media stream and to evaluate the motion of various video objects in a video signal. During the motion estimation process, the relative position of one or more video objects in reference video fields and frames is evaluated. Following the motion detection, only relative motion is encoded thus greatly improving the compression efficiency and visual quality.

In video compression, motion compensation describes a picture in terms of where each section of that picture came from, in a previous picture. This is often employed in video compression. A video sequence consists of a number of pictures—usually called frames. Subsequent frames are very similar, thus, containing a lot of redundancy. Removing this redundancy helps achieve the goal of better compression ratios.

A first approach would be to subtract a reference frame from a given frame. The difference is then called residual and usually contains less energy (or information) than the original frame. The residual can be encoded at a lower bitrate with the same quality. The decoder can reconstruct the original frame by adding the reference frame again.

A more sophisticated approach is to approximate the motion of the whole scene and the objects of a video sequence. The motion is described by some parameters that have to be encoded in the bit-stream. The pixels of the predicted frame are approximated by appropriately translated pixels of the reference frame. This gives much better residuals than a simple subtraction. However, the bitrate occupied by the parameters of the motion model must not become too large.

Usually, the frames are processed in groups. One frame, preferably the first, is encoded without motion compensation, using information only from itself. This frame is called the I-frame, I-picture, or an intra-coded frame in MPEG terminology. The other frames are called P-frames or P-pictures and are predicted from the I-frame or P-frame that comes (temporally) before it. The prediction schemes are, for instance, described as IPPPP, meaning that a group consists of one I-frame followed by four P-frames.

Frames can also be predicted from succeeding frames. The succeeding frames have to be encoded before the predicted frames. Clearly, in such an embodiment the encoding order does not match the original frame order. In such an embodiment, frames can be predicted according to preceding and succeeding frames. For example, a frame to be predicted can be predicted according to I-frames or P-frames that either immediately precede or immediately follow the frame to be predicted. These bidirectionally predicted frames are called B-frames. A coding scheme could be, for instance, IBBPBBPBBPBB.

The efficiency of the compression and the visual quality of the resultant stream depends on a number of characteristics of the compressed signals. In order to increase the efficiency of the compression process, several compression modes and methods are used. In order to choose the most effective compression method and mode, a rate distortion optimization (RDO) processor may be used. The RDO processor preferably estimates the efficiency of each possible compression mode by calculating the outcome of the following equation for each one of the possible compression methods and modes:

Vₘ=C(Rₘ,Dₘ)

where

Rₘ denotes the rate of the resulting compressed video signal by using compression method m.

Dₘ denotes the distortion, such as the mean squared error (MSE) of the compressed and restored media signals in relation to the values of the original media signals when a compression method m is used.

C denotes a cost function in which the values Rₘ and Dₘ are represented in a certain relation.

Vₘ denotes the current value of function C for method m.

The compression method that yields the lowest Vₘ is chosen for compressing the media signals. Preferably, C=Dₘ+λRₘ, wherein λ denotes a constant value which is determined according to the quantization level.

In one embodiment of the present invention, a plurality of compressed media streams is multiplexed by a data multiplexor/demultiplexor unit in order to create a higher-level data stream. Preferably, the data multiplexor/demultiplexor unit embeds additional data such as timing information, digital rights management (DRM), and code redundancy for fault tolerance into the higher-level data stream. Preferably, additional data streams that comprise still images, music files, electronic programming guides, html, additional video and audio streams, vertical blanking interval (VBI) data such as closed caption and teletext, security keys, internet pages, or a combination thereof may be embedded into the higher-level data stream by the data multiplexor/demultiplexor unit.

Preferably, the higher-level data streams, that comprise multiplexed compressed streams, are encrypted by a data encryption/decryption processor using a certain encryption/decryption algorithm. Any of a variety of different encrypting algorithms, such as a content-scrambling system (CSS) algorithm, a data encryption standard (DES) algorithm, an advanced encryption standard (AES) algorithm, and the Rivest Shamir Adelman (RSA) algorithm, may be employed. Such an embodiment enables the implementation of copyright protection, conditional access and DRM modules. The data encryption/decryption processor may also comprise a linear feedback shift register (LFSR) which is used as a pseudo-random number generator for ciphering of the media streams, the seed of which can be either programmed or generated by true random number generator source.

In another embodiment of the present invention, the media CODEC is operated in Transcoding mode. Transcoding is the direct digital-to-digital conversion from one encoding method (for example MPEG-2) to another (for example, MPEG-4). Transcoding involves decoding/decompressing the original data to a raw intermediate format (i.e. PCM for audio or YUV for video), in a way similar or identical to standard playback, and then re-encoding this into the target format. Transcoding can also refer to recompressing streams to a lower bitrate without changing compression methods. Transcoding is used for interoperability due to the diversity of content encoding methods. This diversity requires an intermediate stage of content adaptation in order to make sure that the content source will be adequately presented on the target device to which it is sent.

One embodiment of the present invention is related to media signal decompression in home gateways and other network edge devices. As described above, the electronic circuit comprises a multistandard multi-channel media processor, which is designed for encoding and decoding media streams using one or more compression and decompression algorithms. The electronic circuit may further be used for decrypting, demultiplexing, and playing back the compressed media signals.

The data encryption/decryption unit is used for decrypting one or more encrypted multiplexed compressed streams. In some embodiments of the invention, some of the media streams are further indexed, re-encrypted using the same or a different encryption method and transferred to external devices such as memory or to a hard disk drive (HDD), for later playback (personal video recorder application).

The data multiplexor/demultiplexor unit is used for demultiplexing one or more unencrypted multiplexed compressed streams into separated compressed media streams, among them streams of quantized video coefficients, audio streams, data streams and compressed still images. The multiplexing is preferably done while maintaining lip-synchronization of the associated video signals and audio signals.

In one embodiment of the present invention, the stream of quantized video coefficients is further decompressed by a multi-standard video encoder/decoder processor. Such decompression may include inverse spatial transformation and inverse quantization, as further described below. Preferably, if the aforementioned motion estimation processor is used as part of the compression process, as described above, an equivalent process such as a motion compensation process is employed during the decompression, preferably by a multi-standard video encoder/decoder processor. The output of this process is a restored video signal that resembles the original video signal.

In one embodiment of the present invention, the restored video is processed by a postprocessor, in order to change the parameters of the video signal and to improve its visual quality, inter alia, by reducing visual artifacts. Such post-processing may include different image processing techniques such as up-scaling or down-scaling of the picture, color format conversion, edge enhancement, noise reduction, deblocking, deringing, or any combination thereof. Such postprocessing may also include de-interlacing and inverse 3:2 and 2:2 pull-down detection.

In one embodiment of the present invention, a still image encoder/decoder processor is used to derive still images, which are transmitted as part of a multiplexed compressed stream, or from external peripherals (such as USB), modems etc., and to decompress them. The still image encoding/decoding (ENDEC) processor supports various still image compression and decompression algorithms such as the joint photographic experts group (JPEG) format, the graphics interchange format (GIF), the Portable Network Graphics (PNG) format, etc.

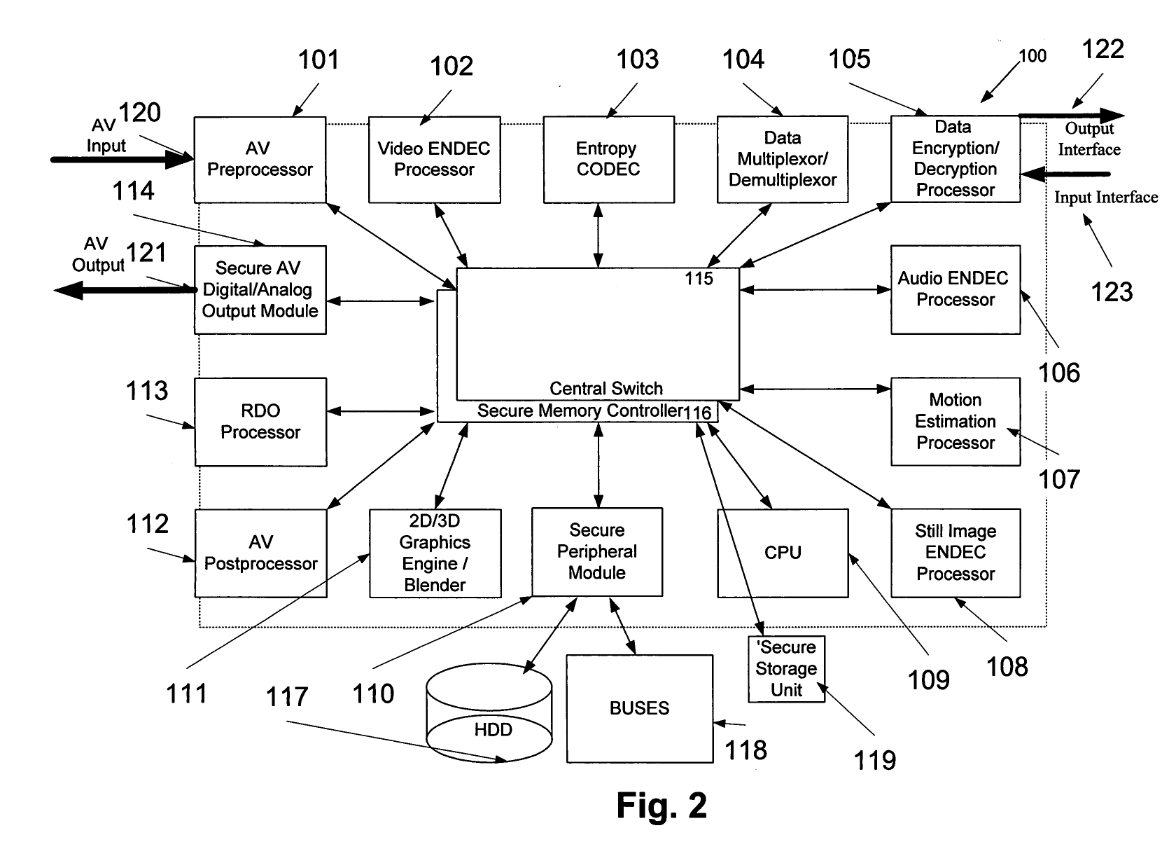

In one embodiment of the present invention, several 2D and 3D graphic planes are generated by a 2D/3D graphics engine/blender. Such graphic layers may comprise text, drawings, 2D and 3D pictures, Internet pages, interactive menus, 2D and 3D electronics game screens, etc. The 2D/3D graphic engine/blender is a powerful processor that is designed for generating high-resolution 2D and 3D graphics in real time. Preferably, the 2D/3D graphics engine/blender is designed to generate one or more graphic planes that include graphical objects in accordance with control commands, which are extracted from multiplexed compressed data streams by the data multiplexor/demultiplexor 104 (FIG. 2), or from an internal embedded system CPU, or from external controller or CPU. The 2D/3D graphic engine/blender is preferably designed to perform designated operations such as generating raster graphic objects and Bit Block Transfer (BLT).

Preferably, the AV postprocessor/blender is designed for generating a composite video layout that combines several of the following: video streams, still images and graphic planes. The composite video streams may originate from uncompressed and decompressed digital video streams. In some embodiments of the invention, an Alpha blending scheme is used to generate the composite video layout

Preferably, compressed audio signals are decompressed by a multistandard audio ENDEC processor. Various algorithms which are defined according to various protocols, such as MPEG1, AC-3, AAC, MP3 and others, may be used during the decompression process. The Audio ENDEC also blends multiple uncompressed audio channels together, in accordance with control commands, which are extracted from multiplexed compressed data streams by the data multiplexer/de-multiplexer, as shown at numeral 104 of FIG. 2. The commands may alternatively be obtained from an internal embedded system CPU, or from an external off-chip controller or CPU.

Preferably, the composite video layout is output, in a digital form, to an external display or storage device, via a secure output. Preferably, the composite video layout is converted into an analog video signal and output to the external display or storage device in an analog form as prescribed by any one of a range of DRM schemes being used. In one embodiment of the present invention, a DRM scheme such as HDCP is used to protect the digital output port, and Macrovison is used to protect the analog port. It should be noted that, if the composite stream comprises audio signals, it might be output to an external sound device, preferably in a digital format, through a secure audio output device.

One embodiment of the present invention relates to a media system on a chip (SoC) having an authorization module to allow only authorized access to the internal units, including hardware, firmware and software of the SoC.

Preferably, the SoC comprises a secure memory, such as a one time programmable memory (OTP) that stores predefined content that has been programmed during the integrated circuit (IC) manufacturing process and therefore cannot be altered. Such a memory may be, for example, antifuse. The OTP is designed according to known standards, such as commercially available CMOS logic process technologies. It should be noted that, as the programming does not rely on a stored charge, there is no voltage contrast. Likewise, it is not possible to see any change to the transistor materials even under microscope. Therefore, it is not possible to use inductive, IR, or magnetic detection. The OTP is integrated into the chip, such that its content cannot be read by an external device, by any means, including reverse engineering and any other destructive or non-destructive method. Such a secure OTP is used to store authorization keys and additional secret information. The authorization keys may be used during decryption, preferably by using the data encryption/decryption processor, as described below, preferably together with additional keys, which are stored in the streams, and in devices such as Smartcards. Such additional keys allow access to the media CODEC module's units for testing and programming.

Preferably, internal registers and memories, which are embedded into the SoC, can only be accessed by an authorized user who is identified by the authorization module. One purpose of the authorization module is to protect media content from unauthorized usage or theft. Another purpose of the authorization module is to prevent unauthorized access to the secure media CODEC module's internal registers and memories that store parameters, firmware code, and software code, or unauthorized modification thereof. Preferably, data exchange, such as media content or control signal exchange between the SoC and external peripheral devices, such as a HDD and external memory, is encrypted to prevent unauthorized access to such data. In one embodiment of the present invention, the embedded CPU requires the connected external memory or flash memory device to initialize its operating system. Such initialization is secured using known methods, such as secure boot loader, symmetric and asymmetric code signing, and code encryption. Software modules, which are uploaded to the embedded CPU, are encrypted in order to prevent unauthorized access to the software modules.

The principles and operation of an apparatus and method according to the present invention may be better understood with reference to the drawings and accompanying description.

Before explaining at least one embodiment of the present invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

A media stream or media signals may be understood as the analog or digital flow of data from a source to a single receiver. The flow of data may comprise a representation of a plurality of audio channels, video channels, still images, text, graphical objects, instructions, and control signals, and the like.

A home gateway may be understood as a central set top box or any other electronic device, which is designed to produce output on a plurality of analog & digital television set, and is connected to one or more communications channels such as a telephone, an integrated services digital network (ISDN), an optical fiber, ADSL, a wireless transmission or a DOCSIS cable modem, in addition to a “content source”, and the like.

A content source may be understood as a cable feed, a satellite feed, a digital versatile disc (DVD) player, a high density (HD)-DVD player, a Blu-Ray player/recorder, a camcorder, a hard disk, a digital video recorder (DVR), a personal recorder, a still camera, a place-shifting TV device, an external consumer electronic video appliance, a portable memory device, the Internet, a local area network (LAN) connection, a home network, a video cassette recorder such as a Video Home System (VHS), a telephone, a wireless media connection, and the like.

A processor or a processing unit may be understood as an execution unit, a processing unit that is available at a particular instant, a processing unit that is available when certain information of a processing procedure is presented thereto, a central processing unit, a designated processing unit, etc.

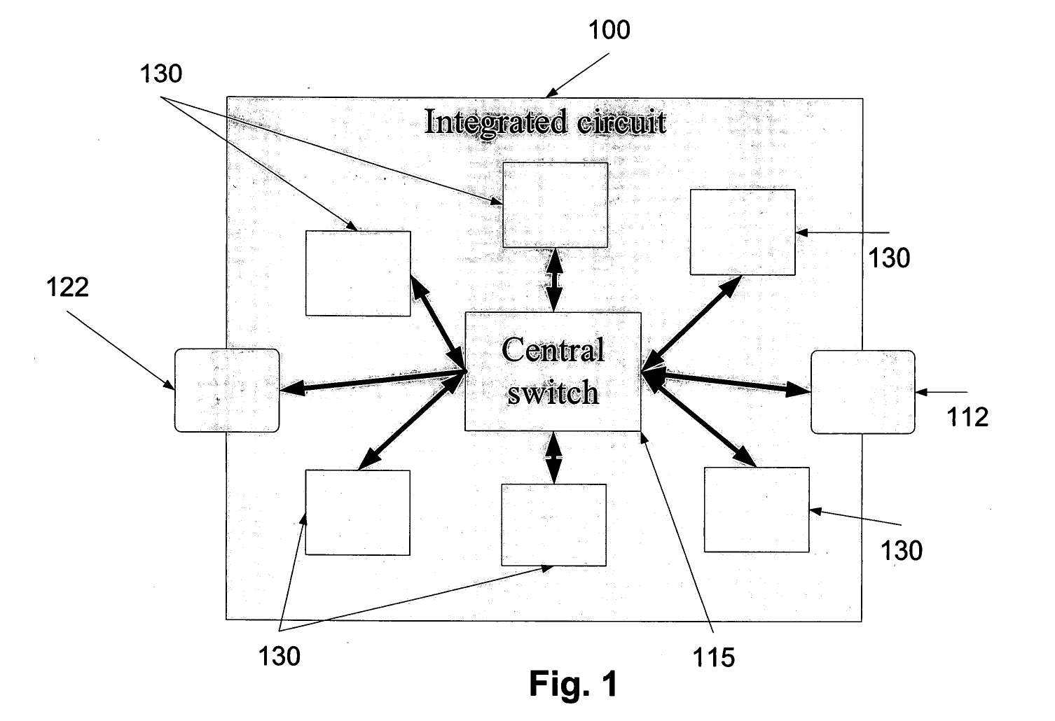

Reference is now made to FIG. 1, which is a schematic illustration of an integrated circuit 100 for processing one or more media streams, in accordance with one embodiment of the present invention. The depicted integrated circuit 100 comprises an input interface 123 for receiving the media streams from a plurality of content sources (not shown). The received media streams are transferred to a central switch 115. The central switch 115 is directly connected to a number of processing units 130. As further described below, the central switch 115 allows communication between any two processing units. The processing of the media stream by the processing units 130 is done simultaneously, with all or several pairs of processing units being able to communicate in parallel at any given time. The integrated circuit 100 further comprises an output interface 122, which is connected to the central switch 115, and outputs the processed media stream. Such an integrated circuit 100 can be used as a media encoding and decoding device that allows efficient processing of one or more media streams.

Reference is now made to FIG. 2, which is a schematic illustration of a media CODEC integrated circuit 100 with a central switch 115 for handling a number of channels according to a number of securing standards, as described above, in accordance with one embodiment of the present invention. The media CODEC 100 comprises a number of integrated units such as possessors, preprocessors and peripheral modules. In one embodiment of the present invention, the media CODEC 100 comprises an audio/video (AV) preprocessor 101, a video ENDEC processor 102, an entropy CODEC 103, a data multiplexor/demultiplexor unit 104, a data encryption/decryption processor 105, an audio ENDEC processor 106, a motion estimation processor 107, a still image ENDEC processor 108, an embedded CPU 109, an embedded secure peripheral module 110, a 2D/3D graphics engine/blender 111, an AV postprocessor/blender 112, an RDO processor 113, and a secure AV analog/digital output module 114. A detailed description of the internal architecture is provided below:

The AV Pre-Processor 101

The AV preprocessor 101 receives a number of video and audio signals from an AV input 120 or from the secured storage unit 1119. The AV input 120 is connected to one or more media sources which simultaneously transmit media streams. The AV preprocessor 101 may include a digitizer or a video decoder for converting analog video into digital form, a digital input, preferably CCIR656 interface, digital video interactive (DVI), high-definition multimedia interface (HDMI) interface and the like. In addition, the preprocessor 101 preferably has an array of filters for allowing spatial and temporal filtering of the received video and audio signals. Additional signal processing processes, such as linear and nonlinear noise reduction and video resolution change, may be employed as well. The preprocessor preferably has analysis capabilities, such as scene change detection, zoom in/out, fade-in/out and the like. The preprocessed video signals are transmitted to the motion estimation processor 107, either directly via a direct link, or via the central switch 115, or to a secure storage unit via the secure memory controller 116.

The Video ENDEC Processor 102

The video ENDEC processor 102 preferably compresses the preprocessed digital video according to more than one compression mode or method. The video ENDEC 102 is responsible for removing the spatial redundancy of the video signal. Preferably, video ENDEC 102 performs motion compensation and creates a residual video signal by deducting a reference video earlier generated and stored by a feedback loop as described below, from the preprocessed original video signal received from AV preprocessor 101. In another embodiment of this invention, video ENDEC 102 creates residual video by using prediction formed from the restored video signal generated by the feedback loop, as described below, in a process called intra-prediction, which may be implemented in a variety of forms and options. In yet another embodiment of the present invention, no residual video is formed and the preprocessed original video signal is encoded directly, preferably in a process known as intra encoding. Preferably, the residual video is then undergoes spatial transformation, for example discrete cosine transform (DCT) or AVC integer transform, which converts video signal into different domains where the effects of quantization are less susceptible to human visual system. Preferably, the resulting DCT coefficients are further quantized. In another embodiment of the present invention, a residual DCT signal is calculated using DCT coefficient predictors from earlier encoded and reconstructed blocks generated by the feedback loop as described below. Such a differential DCT signal is further quantized. Quantization processing results in a reduction of number of bits in binary representation of each DCT coefficient, thus reducing the overall bitrate of the video signal. In another embodiment of this invention, the DCT coefficients are not quantized. In yet another embodiment of this invention, each DCT coefficient is quantized differently, resulting in removing or adding different numbers of bits in each DCT coefficient's binary representation. The video ENDEC processor 102 preferably uses the cost-quality analysis information from the RDO processor 113 and video statistical analysis from the AV Processor 101 to optimize the encoding process. The quantized DCT coefficients along with additional data, parameters and information are transferred to the entropy codec 103 preferably through the central switch 115 or directly. In another embodiment of the present invention, such quantized DCT coefficients undergo inverse quantization and inverse spatial transformation so that a video signal close to the preprocessed original signal is restored. In one embodiment of the present invention, such a restored video signal is further filtered to remove the visual effects of quantization such as blocking effect, preferably in a de-blocking process. The process of inverse quantization, inverse spatial transform and preferably de-blocking filtering comprises a feedback loop referenced above. The restored and preferably filtered signal is stored, preferably in external secure storage 119, for future use as a reference video in a motion compensation process. Such a restored signal is also used in intra frame prediction as referenced above.

In another embodiment of the present invention, during decoding, the video ENDEC processor 102 performs one or more video decompression sequences such as inverse quantization, inverse spatial transformation, motion compensation, de-blocking and/or de-ringing filtering or any other processing that may be required according to the compression algorithm by which the video stream was compressed. After the image processing actions are finalized, the video ENDEC processor 102 outputs the reconstructed video streams and transfers them to the AV postprocessor 112, preferably via the central switch 115, the secure memory controller 116, or a direct link.

The Entropy CODEC 103

The entropy CODEC 103 is designed to receive quantized transformation video coefficients and to perform entropy coding of quantized coefficients to create a compressed video bitstream, which is transferred to data multiplexor/demultiplexor 104. Entropy encoding is a coding scheme that assigns codes to symbols to match code lengths with the probabilities of the symbols. Typically, entropy encoders are used to compress data by replacing symbols represented by equal-length codes with symbols represented by codes where the length of each codeword is proportional to the negative logarithm of the probability. In entropy encoding, the most common symbols use the shortest codes and less common signals use progressively longer sequences in their codes.

Preferably, the entropy CODEC 103 uses Huffman coding, arithmetic coding, unary coding, Elias gamma coding, Fibonacci coding, Golomb coding, or Rice coding and the like. The entropy CODEC 103 preferably supports:
Context-adaptive binary arithmetic coding (CABAC), which is a technique of lossless compression of syntax elements in the video stream based on the probabilities of syntax elements in a given context
Context-adaptive variable-length coding (CAVLC), which is a lower-complexity alternative to CABAC for the coding of quantized transform coefficient values.
A common simple and highly-structured variable length coding (VLC) technique for many of the syntax elements not coded by CABAC or CAVLC, also called Exponential-Golomb coding.

In one embodiment of the present invention, during decoding, if the compressed streams comprise video streams, the entropy CODEC 103 receives compressed video bitstreams from data multiplexor/demultiplexor 104, preferably via central switch 115, the secure memory controller 116, or a direct link. The entropy CODEC 103 performs bitstream decoding, entropy decoding and reconstruction of quantized transformation video coefficients on the received compressed video signals. Then, the video signals are transferred to the video ENDEC processor 102, preferably via central switch 115, the secure memory controller 116, or a direct link.

Multiplexing/De-Multiplexing Processor 104

The multiplexer/demultiplexer 104 receives encrypted bitstreams of video, audio, still images and ancillary data, from the encryption/decryption processor 105, preferably via central switch 115 or via the secure memory controller 116. The multiplexor/demultiplexor 104 is designed to multiplex and format the received bitstream, thereby to create one or more combined streams, preferably in the form of an MPEG2 transport, program stream, IP packets, or packet format, which is defined by internet streaming media alliance (ISMA) specifications, or by other stream formats. Then the multiplexor/demultiplexor 104 transfers the encrypted streams via an output interface 122 to the secured storage unit 119, the HDD 117, the BUSES 118, or a peripheral which is connected to the media codec.

In one embodiment of the present invention, several of the generated transport streams are indexed in a manner that allows trick play functions, such as fast forward, fast backward, replay etc., and are transferred, preferably after re-encrypting, to the external HDD 117 for storage and future decryption, demultiplexing, decompression and playback. The indexing can be done according to the frame type (I, P or B), according to a frame number, or based the video content such as a detection and tagging of substantial movement, a scene change etc. Indexing can also be performed according to user preferences, a certain EPG search or selection, channel selection and the like.

Preferably, tags and indexes can be attached to items in one or more frames according to any predefined method. Then, in trick play itself, all the frames indexed in a certain way are played. So fast forward could comprise of a certain number of frames per scene, or every I frame, or other schemes that will be apparent to the skilled person. In addition combinations of indexes could be used.

In another embodiment of the present invention, during decoding, the data multiplexer/de-multiplexer 104 receives encrypted compressed streams from an input interface 123, and demultiplexes the compressed streams, thereby generating compressed video, audio, still images and auxiliary data streams. Preferably, the encrypted streams are transferred to the Data encryption/decryption processor 105 for decryption, preferably via central switch 115, via the secure memory controller 116, or by a direct link. Preferably data multiplexor/demultiplexor 104 also identifies the compression method used to compress video, audio, still images etc. and provides this information to video ENDEC processor 102, entropy CODEC 103, audio ENDEC processor 106 etc. Preferably and in parallel, several of the transport streams decrypted by the data encryption/decryption processor 105 are transferred to the data multiplexor/demultiplexor processor 104 and indexed in a manner that allows the implementation of trick plays such as fast forward, fast backward, etc., and are transferred, preferably after re-encrypting, to the external HDD 117 for storage and future decryption, demultiplexing, decompression and playback.

Data Encryption/Decryption Processor 105

The data encryption/decryption processor 105 encrypts the compressed streams according to a certain encryption algorithm, and in accordance with a variety of DRM schemes. It should be noted that any of numerous decryption algorithms such as CSS, AACS, ASE, DES, RC4, RSA, ECC and others might be used to encrypt the streams. The encryption algorithms are well known in the art and, hence, will not be described here in detail.

Preferably, the Encryption/Decryption processor 105 generates a plurality of distinct DRM keys (for example, keys to be used exclusively by the Secure Memory Controller 116). Such keys are not held constant but may depend upon certain information kept on the secured OTP, other information taken from external security devices such as SmartCards, and yet other information taken from an on-chip True Random Number Generator (not shown in FIG. 2) and the like.

A true random number generator is a computational or physical device or combination thereof, designed to generate a sequence of numbers, or symbols that lack any pattern, i.e. are truly random.

An additional security element of the Encryption/Decryption processor 105 is the “Downloadable Conditional Access System” or DCAS, which defines a standard for secure download of a specific Conditional Access client (computer program) which controls DRM into an Open Cable Application Platform (OCAP)-compliant host consumer media device. OCAP incorporates standard APIs directly into host media devices, thus turning them into small processors. DCAS is a component that eliminates the need for physical set-top boxes or CableCARDs currently required protecting encrypted digital content. The DCAS scheme is not limited to OCAP, and can be found in multiple other applications, such as IPTV, DTV etc.

The basic purpose of DCAS is to implement DRM protection in software, supported by, for example, OCAP-compliant consumer devices such as digital televisions, DVRs, and set-top boxes. Such an implementation secures the information transmitted in the link between the cable company and the consumer device.

DCAS provides greater security because it allows the changing of an entire security structure by downloading new software into host devices. If a particular encryption algorithm is cracked, it can be replaced by another one. Additionally, DCAS-based devices may incorporate internal support for a kind of “smart card” (similar to the current SIM chip in a GSM cell phone) to identify the subscriber and provide further protection.

The encryption/decryption processor 105 preferably contains secured OTP, a DCAS processor, a true random number generator, and other hardware based processors for generating and exchanging secure DRM keys with external interfaces such as SmartCard and CableCard, Satellite & Cable head-ends, IEEE1394 (Firewire) DTCP based equipment, with DTVs equipped with DCAS and the like. Preferably, the DCAS processor is used to generate secure keys used to encrypt the streams, and provide communication with the HDD 117, BUSES 118, AV-Output 121, keys needed for the secure memory controller 116 and the like. Such keys are preferably generated and transferred to the applicable processors directly, and without the intervention of the system CPU 109 or other processors. These keys shall be preferably stored in non-accessible sections of the applicable units (for example, in write-only registers of the secure memory controller 116), with the aim of preventing any access, disassembling, hacking or otherwise. Preferably, the DRM keys are never exported or stored outside device 100.

In another embodiment of the present invention, during decoding, the data encryption/decryption processor 105 decrypts compressed streams according to a variety of decryption algorithms and transfers decrypted streams to subsequent units 130 (for example, the Entropy CODEC 103), preferably the central switch 115, the secure memory controller 116, or a direct link. The data decryption processor makes use of its internal OTP, DCAS processor, true random number generator, and access external secured peripherals such as SmartCard and the like, in order to encrypt & decrypt media streams, in accordance with a variety of DRM schemes.

Audio ENDEC Processor 106

Preferably, if the preprocessed signals are audio signals, they are transferred to the audio ENDEC processor 106, preferably via the central switch 115, the secure memory controller 116, or a direct link. The audio ENDEC processor 106 is designed to compress the audio signal according to a certain audio compression algorithm. The compressed audio bitstream is then transferred to the data multiplexor/demultiplexor 104, preferably via the central switch 115, the secure memory controller 116, or a direct link.

In another embodiment of the present invention, during decoding, if the compressed streams comprise audio streams, the data multiplexor/demultiplexor 104 forwards the compressed audio signals to the audio ENDEC processor 106, preferably via the central switch 115, the secure memory controller 116, or a direct link. The audio ENDEC processor 106 receives the compressed audio signals and decompresses them in accordance with the audio compression algorithm that was used to compress such audio. The audio ENDEC processor 106 generates a reconstructed audio signal, which is transferred to the AV postprocessor 112, preferably via the central switch 115, the secure memory controller 116, or a direct link.

The Motion Estimation Processor 107

The motion estimation processor 107 is designed to analyze the video signals and detect relative motion of one or more video objects of different sizes and shapes vs. their respective positions in previous and future video frames and fields (called reference frames and fields). Such motion information, which may be represented by motion vectors, reference frame and field indexes, etc., is transferred to one or more of the video ENDEC processor 102, the entropy CODEC 103 and the RDO processor 113. The motion estimation processor 107 uses the secure storage unit 119 (via the secure memory controller 116) for accessing relevant information, such as current and reference video frames and fields, temporary variables, motion vectors and reference indexes, cost parameters and the like.

In a preferred embodiment of the Invention, the Motion Estimation Processor 107, may incorporate a specialized cache aimed to reduce the external memory bandwidth requirements.

Still Image ENDEC Processor 108

The still image ENDEC processor 108 preferably compresses still images according to a certain still image compression algorithm and transfers the compressed image bitstream to the data multiplexor/demultiplexor 104, preferably via the central switch 115, the secure memory controller 116, or a direct link. Such image compression algorithms such as JPEG, Motion JPEG, GIF, and PNG are well known in the art and, hence, will not be described here in detail. The preprocessed digital video signals may also be transferred from the A/V preprocessor 101 to the still image ENDEC processor 108, preferably via the central switch 115, the secure memory controller 116, or a direct link. Preferably, a bitstream that comprises one or more compressed or uncompressed still images may be transferred to the still image ENDEC processor 108. The bitstream is transferred from the embedded CPU 109, or from an external device, through the secure peripheral module 110. The resulted compressed (or transcoded) still image bitstream may also be transferred to the embedded CPU 109 or to the secure peripheral module 110, preferably via the central switch 115, the secure memory controller 116, or a direct link.

In another embodiment of the present invention, during decoding, if the compressed streams comprise still image signals, the data multiplexer/demultiplexer 104 forwards the compressed streams to a still image ENDEC processor 108, preferably via the central switch 115, the secure memory controller 116, or a direct link. In another embodiment of the present invention, compressed still images may be received from an external source such as digital camera through secure peripheral module 110, or from embedded CPU 109. The still image ENDEC processor 108 is designed to receive a bitstream of still image signals from the data multiplexer/demultiplexer 104 and to decompress and reconstruct the still image signals in accordance with a compression algorithm that was used to encode such still image signals. The reconstructed still image signals are then transferred to the AV postprocessor 112, preferably via the central switch 115, the secure memory controller 116, or a direct link.

Embedded CPU 109

As depicted in FIG. 2, the media CODEC 100 comprises an embedded CPU 109. The embedded CPU 109 provides computational power that is used to implement user applications, and support and control different functional units of the media CODEC 100, and preferably external units such as the HDD 117, external BUSES 118, and the external secure storage unit 119. The CPU 109 may support application software such as interactive gaming, voice over IP (VoIP), video on demand (VOD), Trick play support, DRM Key exchanges, Encryption/Decryption, DVD navigation, etc.

The embedded CPU 109 is designed to receive external control signals that comprise boot codes, interrupts and software commands from an external source such as an external secure memory, for example from non-volatile flash memory or a read only memory, or from HDD 117, via the central switch 115 and the embedded secure peripheral module 110. The embedded CPU 109 implements a number of software layers that span from the low level real time operating system layer to high level customer specific applications such as VOD, VoIP, DVD player operation, etc. Using the embedded CPU 109, the HDD 117 can optionally be accessed, via the central switch 115, by all the units of media CODEC 100. The Embedded CPU 109 preferably features a fast arithmetic logic unit, intelligent caches, floating point support etc.

Secure Peripheral Module 110

The Secure peripheral module 110 acts like a bridge that provides a secure connection between internal units of media CODEC 100 and external devices that include standard industry buses, electronic appliances, etc. The secure peripheral module 110 may support glueless connectivity to a variety of industry standard buses 118 such as a Universal Serial Bus (USB), a peripheral component interconnect (PCI) bus, a PCI-express bus, an IEEE-1394 Firewire bus, Ethernet & Giga-Ethernet (MII, GMII bus), etc. It also supports glueless connection to devices such as an external HDD 117, preferably via an advanced technology attachment (ATA) or a serial ATA (SATA), an external DVD, a HD-DVD or a Blu-Ray disk through interfaces such as an ATA and integrated drive electronics (IDE), etc. The secure peripheral module 110 may also support a number of connections to a home networking system, such as a Multimedia over Coax Alliance (MOCA) connection, phone lines, power lines, etc. The secure peripheral module 110 also supports a number of low speed peripheral interfaces such as universal asynchronous receiver/transmitter (UART), Integrated-Integrated Circuit (I2C), IrDA, Infra Red (IR), SPI/SSI, SmartCard, plain telephone line etc.

The 2D/3D Graphics Engine 111

The 2D/3D graphics engine 111 is designed to generate graphics planes based on the control signals received from the data multiplexer/demultiplexer 104, embedded CPU 109, an external controller connected to the BUSES 118 or the like, or from the embedded CPU 109, and to combine (blend) a portion or all such graphics planes together. The Graphics planes are then transferred to the AV postprocessor/blender 112, preferably via the central switch 115, the secure memory controller 116, or a direct link.

AV Postprocessor/Blender 112

The AV postprocessor/blender 112 is designed to perform multi-stream video postprocessing sequences such as deinterlacing, de-blocking, de-ringing, noise reduction, edge enhancement, resolution change (i.e., up-scaling & down-scaling), as well as blending of multi-plane multi-stream video, data (for example, HTML), still images and graphics. Preferably, the AV postprocessor/blender 112 transfers postprocessed video signals to a secure AV output 121.

The AV postprocessor/blender 112 is also designed to perform post-processing of the audio sequences such as audio enhancement, multi-stream audio blending, audio watermarking etc. Preferably, the AV postprocessor/blender 112 transfers the postprocessed audio signals to a secure AV output 121. In one embodiment of the present invention, all audio processing activities are performed by the audio ENDEC processor 106, and the audio signal passes directly to the secure AV output 121, preferably via the central switch 115, the secure memory controller 116, or a direct link.

In one embodiment of the present invention, video and audio signals are transferred from an external video source, via the AV input 120, through the AV Preprocessor 101, to the AV postprocessor/blender 112. The video and audio signals are, preferably transferred via the central switch 115, the secure memory controller 116, or a direct link.

In such an embodiment of the present invention, the AV Postprocessor/Blender 112 creates a composite video signal by blending graphics planes generated by the 2D/3D graphics processor 111 with pre-processed uncompressed video signals received from an external video source via the AV input 120 through the AV Preprocessor 101, and preferably processed by the AV postprocessor/blender 112. Preferably, other planes, such as decoded video streams etc. are added to the composite video signal. The composite video signal is then transferred to the secure AV output 121, preferably via the central switch 115, or the secure memory controller 116, or a direct link.

In another embodiment of the present invention, the AV postprocessor/blender 112 creates a sequence of composite video frames which are subsequently transferred to the secured AV output 121, preferably via the central switch 115, the secure memory controller 116, or a direct link.

In yet another embodiment of the present invention, AV postprocessor Blender 112 transfers the composite video frames to the memory controller 116 for further processing, for example for encoding in accordance with the above description.

The Rate Distortion Optimization (RDO) Processor 113

In order to improve the compression efficiency, especially in compression methods such as the H.264/AVC that employ a variety of inter-prediction and intra-prediction compression modes, the preprocessed digital signals are transmitted to the RDO processor 113 before they are compressed by the video ENDEC processor 102. The RDO processor 113 is designed to provide an effective criterion to select the best coding mode for compressing the received digital signals. Preferably, the RDO processor 113 performs a comparative analysis of all possible compression modes. Preferably, the RDO processor 113 performs multiple encoding/decoding processes using a variety of compression modes. Based upon cost (bitrate) analysis and a video quality analysis, the RDO processor 113 selects the optimal compression set of one or more modes.

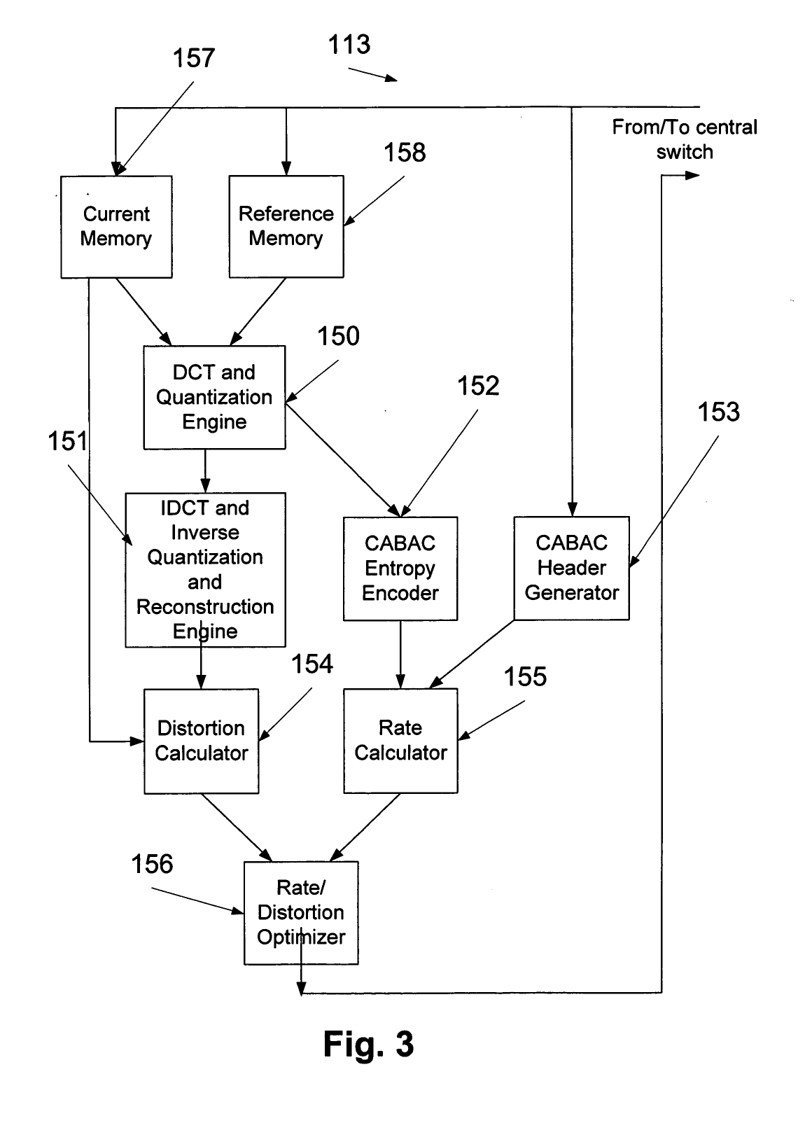

Reference is now made to FIG. 3, which is a schematic illustration of the RDO processor 113, in accordance with one embodiment of the present invention. The RDO processor 113 preferably consists of one or more of the following modules: a spatial transform module, such as DCT and quantization engine 150, an inverse spatial transform module, such as a IDCT, an inverse quantization (IQUANT) module a reconstruction engine 151, a context adaptive binary arithmetic coding (CABAC) entropy encoder 152, a CABAC header generator 153, a distortion calculator 154, a rate calculator 155, a rate/distortion optimizer 156, one or more memories such as a current picture memory 157, a reference picture memory 158, and a reconstructed picture memory (not shown).

In use, a stream of data that comprises a current image is transferred from A/V preprocessor 101 through the central switch 115 (FIG. 2) into the current memory 157, or from the secure storage unit 119, through the secure memory controller 116. Reference image data is read and transferred from motion estimation processor 107, through the central switch 115 (FIG. 2), or from the secure storage unit 119, preferably through the secure memory controller 116, into a reference memory 158. The DCT and quantization engine 150 encodes a new picture by applying spatial transformation, such as DCT, and quantization processes. Then, the quantized coefficients of the encoded picture are transferred to an IDCT, IQUANT and reconstruction engine 151 that is used in order to resemble a decoding path that allows reconstruction of the picture. In parallel, the quantized coefficients are transferred to the CABAC entropy encoder 152 to perform further entropy encoding which is required in order to calculate the rate of the compressed data.

Preferably, in one embodiment of the present invention, RDO processor 113 performs a complete encoding and decoding process. In another embodiment of the present invention the encoding and the decoding processes, which are performed by the RDO processor 113 are preferably simplified and generate results, which are approximate but not identical to the actual encoding/decoding results. Preferably, in one embodiment of the present invention, approximation processes are used to simplify the spatial transformation process, the inverse spatial transformation process, the quantization process, the inverse quantization process, the entropy encoding, etc., in order to simplify the hardware or the software of the RDO processor. It should be noted that approximation processes are also used to speed up the RDO process and sub-processes.

The distortion calculator 154 is used for calculating the distortion between the current image and the reconstructed image based on a calculation of a mean square error or similar function. A rate calculator 155 may be used to count the actual number of bits which are required to entropy-encode the quantized coefficients, including auxiliary information, such as headers are required by specific video compression standards. Such auxiliary information may be provided by a CABAC header generator 153. As depicted in FIG. 3, the rate/distortion optimizer 156 receives the distortion and the rate and calculates a cost function based thereupon.

During the aforementioned operation, the RDO processor 113 processes a large number of compression options that could vary from a few dozen compression options to a few hundred compression options per basic video object. Such an object may be a 16×16 pixel macroblock.

It should be noted that the number of options and modes is especially high if the signals are encoded according to advanced video coding protocols, such as the H.264/MPEG-4/AVC compression protocol, that employ a variety of inter-prediction and intra-prediction compression modes.

The number of possible options and modes can also be especially high if the encoding method comprises of bi-predictive (B) pictures. In such an embodiment, each picture in the sequence, which can be either a frame or a field, is partitioned into a number of fixed-size macro-blocks that cover a rectangular picture area of 16×16-samples of the Luma component and 16×16, 8×16 or 8×8 samples of each of the two Chroma components. For each Luma component of each such macro-block, the RDO processor 113 evaluates all inter-prediction partition and sub-partition options (16×16, 16×8, 8×16, 8×8 partitions, 4×4, 8×4, 4×8 sub-partitions), forward, backward, interpolated and direct prediction for each of the partition and sub-partition option, four options for intra 16×16 prediction, nine options for Intra 4×4 prediction, nine options for Intra 8×8 prediction. Preferably, RDO processor 113 also evaluates all associated chroma prediction modes. Therefore, the number of encoding and decoding iterations, which have to be performed by RDO processor 113 for compressing each macroblock, is well over a hundred. For each macroblock, the RDO processor 113 preferably identifies the mode with the lowest rate/distortion cost function generated by the rate/distortion optimizer 156 and transfers this information to video ENDEC processor 102 and entropy codec 103 through the central switch 115.

Secure AV Analog/Digital Output Module 114

In one embodiment of the present invention, the secure AV analog/digital output 114, receives a plurality of composite audio/video signals from the AV Postprocessor/blender 112, and outputs such video and audio in digital form, or converts them to and outputs them in analog form, or a combination thereof. The secure AV analog/digital output 114 preferably further implements one or more copy protection schemes. For example, for digital video/audio streams, a copy protection scheme such as a HDCP™ for a HDMI may be implemented. For analog video streams, copy protection schemes such as Macrovision™ or Dwight Cavendish System copy protection scheme may be implemented. For an analog audio streams, a copy protection scheme such as Verance audio watermarking may be implemented. It should be noted that any other copy protection scheme that can prevent unauthorized access or illegitimate usage may also be implemented. Via the secure AV output 121, the signals are transferred to an external display device or sound device after being authorized and after one or more of the above schemes have been implemented. In another embodiment of the present invention, one composite video signal is sent to the analog output 121, while another composite video signal is sent to the digital output 121. In yet another invention, a number of composite video signals are sent to a plurality of analog outputs 121, and yet another plurality of composite video signals are transferred to the digital video outputs 121.

Central Switch 115

Data communication between any two units of the media CODEC 100 is preferably transferred via the central switch 115. The central switch 115 allows any two units to communicate with each other in a bidirectional point-to-point interface. Preferably, several or all pairs of units are allowed to communicate with each other in parallel using the central switch 115. The communication of one pair of units is done without disrupting the communication of another pair of units. In another preferred embodiment, a peripheral unit (the initiator), can transmit to multiple target units.

The central switch 115 allows simultaneous processing of commands & transfer of data from a number of initiating units and replies from target units. The central switch 115 preferably comprises an n-to-n interconnection bus system that allows use of a parallel access path between a plurality of initiating and target units in the system. The interconnection bus system provides multiple advantages such as significant increase in overall data throughput, software flexibility etc. In addition, the architecture of the CODEC 100 can be upgraded with additional peripheral units without any performance degradation, as each unit connects to the central switch matrix. The interconnection bus system may be realized by using a complex interconnection matrix.

For example, the AV preprocessor 101, which functions as an initiating unit, may transfer video streams to the video ENDEC processor 102, which functions as a target unit. At the same time, the encryption/decryption processor 105 and the still image ENDEC processor 108, which function as initiating units, have the ability to respectively transmit a decrypted stream and a still image to the data multiplexor/demultiplexor unit 104 and to the 2D/3D graphics engine/blender 111 respectively. The central switch 115 may be designed to manage a queue of requests for data and memory accesses, allowing a number of units to communicate with a common unit, as further described below.

The central switch 115 reduces the number of local-bus-interfaces between units, and creates a socket for inter-connectivity. However, in other embodiments of the invention, and without loss of generality, media CODEC 100 may have direct local bus interconnectivity in between several peripheral units, in addition to the central switch 115.

As described above, the central switch 115 connects all units of the media CODEC 100 in a wide bidirectional point-to-point interface, or using a serial high-speed bus. Each unit can function as a target unit as well as an initiating unit. As an initiating unit, the unit is designed to transfer commands such as an issue command, a complete command, a read command, and a write command. The central switch 115 ensures that a unit, which is defined as a target unit, receives data from only one associated initiating unit at a time, while the other initiator's requests/data is either delayed or queued. The central switch 115 preferably supports simultaneous communication between more than one pair of target and initiating units. For example, a communication session between a pair of units X and Y and a communication session between a pair of units Z and W can be held simultaneously.

Preferably, the central switch 115 allows different processing units to communicate with a common unit using time division multiplexing. The central switch 115 combines multiple data streams in a single signal by separating the signal into many segments, each having a limited duration. For example, when both units A and B want to communicate with a unit C, the communication will be time multiplexed and the unit C will receive a multiplexed signal.

Preferably, each package of information that is transmitted by one of the units comprises a memory mapped address space Each such package contains an address segment of 16 bits, which represents the target unit, and a data segment of 32 bits. Some part of the address segment may be mapped onto internal configuration registers, microcode memory, data memory, and other components of the target unit.

As depicted in FIG. 2, a communication bus connects between the different units and the central switch 115. The time that it takes to complete a request on the communication bus is not limited, nor is it known in advance. Thus, the central switch 115 may comprise a queue to further optimize and balance such transfer. Whenever an initiating unit issues a command, the central switch 115 may not immediately pass the command to the target, as the target may be communicating with another unit or may be in the middle of a computing task. In such a case, the response to a command may be delayed. For example, if, during a communication session with a certain target unit, an initiating unit targets an address mapped in the target unit's internal memory that is currently being accessed or associated with another unit or by the target unit itself, the target unit will delay the execution of the memory access action.

In one embodiment of the present invention, an initiating unit can operate in a normal single-access mode. In such a mode, the initiating unit issues a single pending command before issuing any other command. The target unit sends a reply to the initiating unit. In a preferred embodiment, the reply is sent as a read or a write completion event.

For example, the transmitting and receiving of such a pending command may be performed in several steps, each of the steps lasting for several cycles. At the first step, that preferably consumes one cycle, a single pending command, which is defined as a read/write command, is generated by the initiating unit. Then, during the following step, that preferably consumes (2+X) cycles, the central switch 115 receives the command and passes it to a related target unit, where X denotes the central switch 115 response time, in clock cycles. During the following step, which preferably consumes (1+Y) cycles, the target unit generates and transmits a response to the central switch 115, where Y denotes the target unit's response time, in clock cycles. During the following step, which preferably consumes one cycle, the central switch 115 forwards the reply to the initiating unit. Thus, the total access time of a single pending command consumes (5+X+Y) cycles. Clearly, the minimum cycle time for a single pending command is five cycles, assuming that the central switch 115 and the target unit can respond immediately and that the initiating unit can issue the single pending command immediately. Although such a method may reduce the arbitration hazards and variable response time of the target, the execution time of the method is relatively high.

In an embodiment of the present invention, an initiating unit can operate in a pipeline mode. In such a mode, messages can be transferred during every clock cycle. When the pipeline mode is implemented, the response time of the central switch 115 to an active initiating unit is substantially zero and the target unit's response time is a predefined constant which is different from zero, for example 6.

In order to ensure that the response time of the central switch 115 is zero, or substantially zero, the initiating unit is designed to send a lock target command and an unlock target command to the central switch 115. The lock target command indicates that commands to a specified target unit should only be given from the sending initiating unit and that commands from other initiating units should be stalled until the unlock target command is received from the initiating unit.

It should be noted that, in a manner similar to the communication procedure which is employed in the normal single-access mode, in the pipeline mode the communication between the initiating unit and the target unit can be divided into several steps. When using the pipeline mode, the initiating unit has to check (by using known methods, such as semaphores) that the resources of the target unit are available, and are operative for sending and receiving data.

In use, a few steps are performed in order to allow an initiating unit to access the memory of a target unit. In one embodiment for example, six equally timed consecutive steps are performed during target read scenario. During the first step, the initiating unit issues a new access command to central switch 115. The access command comprises the address of a certain segment in the memory of the target unit to which the initiating unit requests access. Then, the central switch 115 forwards the command to a related target unit. The target unit accesses its memory according to the address in the received access command. In the following step, the target unit forwards data from the memory to the central switch 115. The central switch 115 forwards data to the initiating unit. Thus, in order to allow the initiating unit to be able to read from the memory of the target unit, a six-step process with duration of at least six cycles is performed.

Since each one of the steps takes the same amount of time, the initiating unit can transmit an access command every cycle in a sequential pipeline manner. By doing so, the duration of each communication session is reduced. Although reading from the memory of the target unit takes at least six cycles, as described above, after the first reading, new data is received at the initiating unit at every cycle and another access command is transmitted. In the light of the above, it should be noted that the pipeline mode is efficient especially when a large amount of data is requested.

Secure Memory Controller 116

Data transfer between the media CODEC 100 and an external secure storage unit 119 is via a secure memory controller 116. The peripheral units 130 may transfer data, preferably simultaneously, to and from the secure memory controller 116. The secure memory controller 116 manages a queue of data requests and memory accesses, and a queue of priorities assigned to each access request. Preferably, the memory controller 116 comprises a quality of service-dedicated hardware. Preferably, the memory controller 116 automatically allocates memory space and bandwidth according to a certain protocol that is used to manage the memory communication.

Preferably, the secure memory controller 116 is designed to encrypt and decrypt data that is transferred to and from an external secure storage unit 119, in accordance with a variety of DRM schemes. Each memory address is assigned with a different DRM key. The DRM keys are preferably not “constant” but rather are changed according to information which is kept on the secured OTP, taken from external security devices such as Smartcards, or taken from on-chip true random number generator and the like, as explained hereinabove.

In one embodiment of the present invention, several secure keys are provided to the secure memory controller 116 by the encryption/decryption unit 105. The secure memory controller 116 uses the provided keys to create a new set of keys. The new set of keys is used in the encryption process.

Preferably, as depicted in FIG. 2, the secure memory controller 16 is designed to receive information from and to provide information to all units 130 and to further transfer such information to and from at least one external secure storage unit 119 that is connected thereto. For example, the AV preprocessor 101 may request that the secure memory controller 116 read parts of previously stored video fields or frames from the external secure storage unit 119. Alternatively, or in parallel, the data multiplexor/demultiplexor 104 may request that the secure memory controller 116 write compressed media stream to the external secure storage unit 119 for future playback, as in personal video recording applications.

Each of the processors 130 of Media CODEC 100 may use, during its operation, the secure storage unit 119 for accessing relevant information, such as input data, temporary storage, setup parameters, output data areas and the like. Preferably, the access is done via the secure memory controller 116.

### The Encoding Path

In a preferred embodiment of the present invention, the Media CODEC 100 is operated in encoding mode, in which the AV preprocessor 101 receives a number of video and audio signals from an AV input 120 or from the secured storage unit 119 (for example, previously stored signals or a number of composite video frames along with the audio stream). Following the pre-processing, the uncompressed video/audio is transferred to the motion estimation processor 106 that estimates relative motion of video objects in order to remove temporal redundancy of the video signals. The RDO processor 113 then evaluates a variety of compression options and modes and selects the best one in terms of video quality and bitrate, as explained above. The Video ENDEC processor 102 compresses the residual video signal using spatial transformation and quantization; and quantized coefficients are then transferred to the Entropy CODEC 103 that removes the entropic redundancy and forms the video bitstream. The Entropy CODEC 103 channels the encoded video stream into the Data multiplexing/de-multiplexing processor 104. Similarly, the uncompressed audio is channeled into the Audio ENDEC processor 106 that performs audio encoding and channels the encoded audio stream into the Data multiplexing/de-multiplexing processor 104. The Data multiplexing/de-multiplexing processor 104 and the Data Encryption/Decryption processor 105, multiplex the received video and audio packets, create a program or transport stream and preferably encrypt the created stream. Preferably, the transport stream is indexed in a manner that allows the implementation of trick plays, such as fast forward, fast backward, etc. Following the indexing, the encrypted multiplexed streams are transmitted through output interface 122, or transferred to the external HDD 117 or to the secure storage unit 119 for storage, or to the BUSES 118, or transmitted through the Ethernet port, IEEE1394 (FireWire) port, MOCA®, or the like.

### The Decoding Path

In one preferred embodiment of the present invention, the Media CODEC 100 is operated in decoding mode, in which the digital transport streams are acquired by the de-multiplexing processor 104 from interface 123, from HDD 117, or from Secured Storage unit 119 or from BUSES 118, and then decrypted by data encryption/decryption processor 105. The unencrypted transport streams are preferably demultiplexed into separate compressed video and audio streams, still images and auxiliary data by the data multiplexor/demultiplexor processor 104. Compressed video streams are further decompressed by entropy codec 103 and video ENDEC 102 that generates reconstructed video streams. The reconstructed video streams are transferred to AV postprocessor/Blender 112. Preferably, compressed audio streams are decompressed by audio ENDEC processor 106 that generate reconstructed audio signals which are transferred to the AV postprocessor/Blender 112. Compressed still images are preferably decompressed by still image ENDEC processor 108 that generates reconstructed still images which are transferred to the AV postprocessor/blender 112. Graphics planes are preferably generated by 2D/3D graphics processor 111 and transferred to AV postprocessor/blender 112. A number of postprocessed uncompressed video, still images, and graphic planes are preferably blended together into a single composite video signal or a number of composite video signals. The resulting single or multiple composite videos along with the associated audios are transferred through secure AV digital/analog module 114 to AV output 121.

### The Transcoder Path

In the preferred embodiment of the present invention, the Media CODEC 100 is operated in transcoding mode. In this mode, several streams are acquired and decoded following the Decoder Path as described above. These streams are preferably blended, and are further encoded following the Encoder Path described above. The encoded streams are further transmitted or stored in the manner described above.

### Application

Digital STB

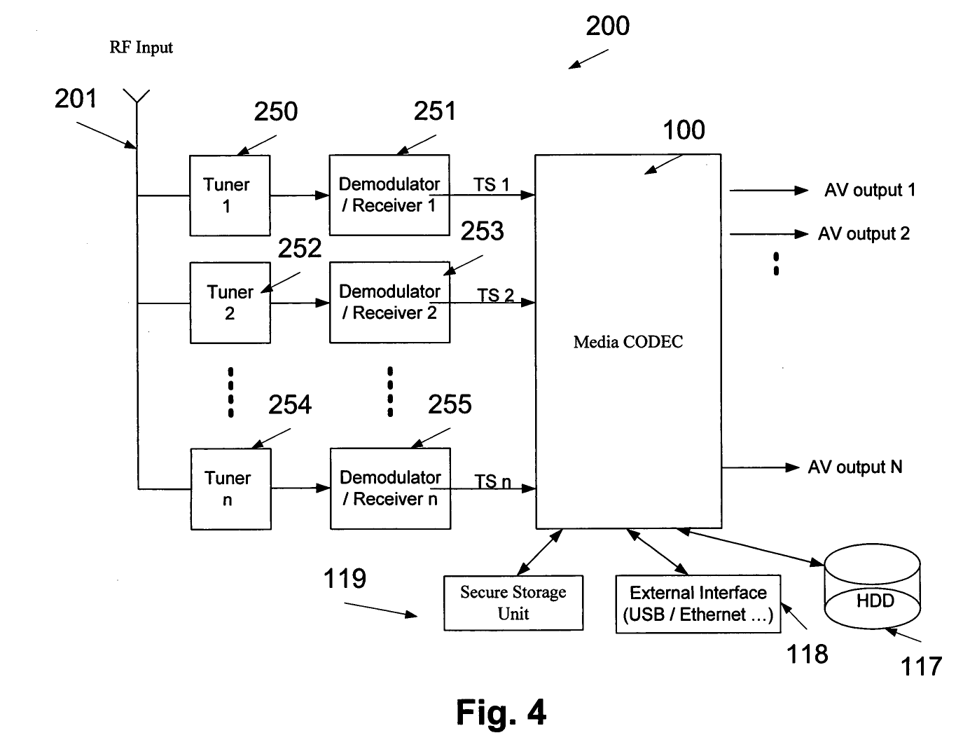

Reference is now made to FIG. 4, which is a schematic illustration of a home gateway or a digital set top box with optional digital personal video recorder 200, in accordance with one embodiment of the present invention. The media CODEC 100, the HDD 117, the external interface 118, and the secure storage unit 119 are as disclosed in shown in FIG. 2 above. FIG. 4 further depicts a set of tuners 250, 252 . . . 254 and a set of corresponding demodulators/receivers 251, 253 . . . 255. In the depicted design, a digital cable (CAB) or satellite (SAT) signal is received via a radio frequency (RF) input 201 and is transferred to an array of N tuners 250, 252, . . . , 254, wherein each tuner is tuned to a different video/audio channel. As depicted in FIG. 4, each tuner of the array of n tuners 250, 252 . . . 254 is connected to a corresponding demodulator/receiver 251, 253 . . . 255. Each one of the demodulators/receivers receives the output of a corresponding tuner and generates a digitized transport stream, TS1, TS2 . . . TSn, that is transferred to the transport stream input 123 of the media CODEC 100. Each digitized transport stream is processed by the media CODEC 100 in parallel or sequential manner or in combination thereof, as described above. The media CODEC 100 is designed to output a reconstructed composite video display and associated audio signal through the AV outputs 1, 2, . . . N to client stations such as analog TVs, digital TVs, and CE appliances such as Video Cassette Recording (VCR) systems, DVD recorders etc.

As described above, the media CODEC 100 processes, de-multiplexes, decrypts, decodes, indexes, post-process, blends, stores & displays simultaneously a plurality of digitized transport streams. Each one of the digitized transport streams may comprise compressed video or audio signals or still images, or a number of audio and video signals and still images in parallel.

Analog/Digital STB

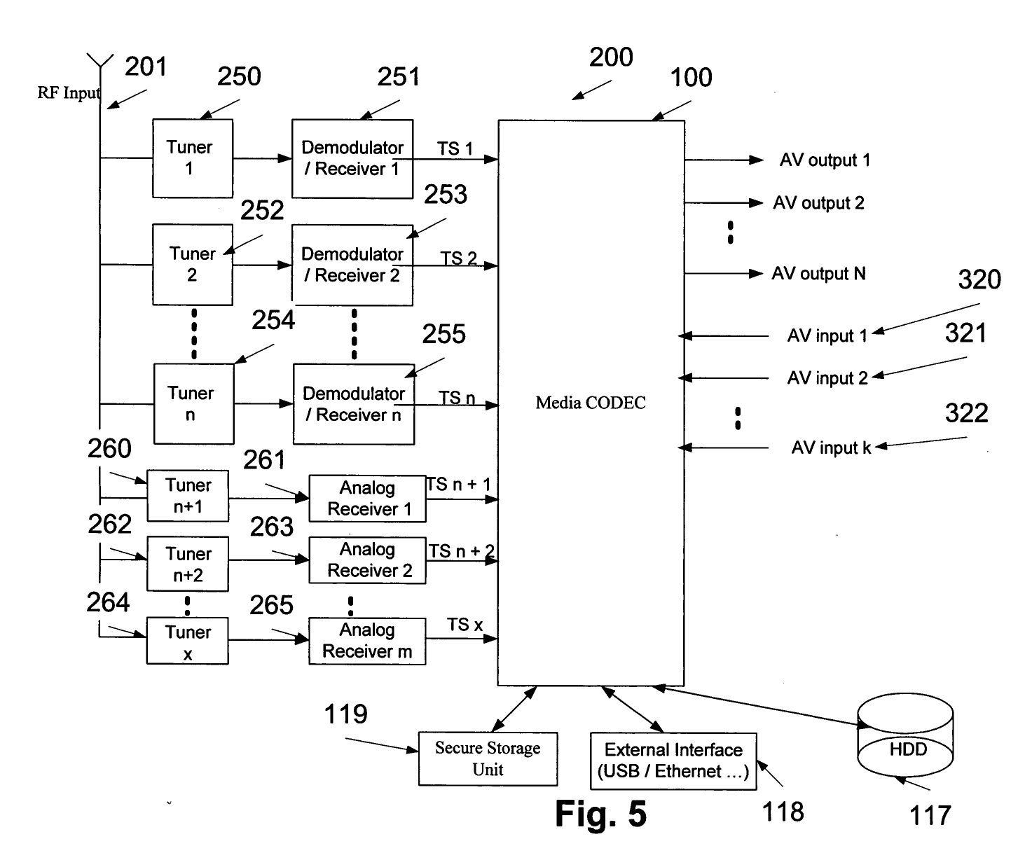

Reference is now made to FIG. 5, which is another schematic illustration of a combined analog-digital home gateway or an STB with optional personal video recorder 200, in accordance with an embodiment of the present invention. The media CODEC 100, the secure storage unit 119, the external interface 118, the HDD 117, the sets of tuners 250, 252, . . . , 254, and the demodulators/receivers 251, 253, . . . , 255 are as shown in FIG. 4 above. However, FIG. 5 further depicts a number of additional tuners 260, 262, 264 and analog channel receivers 261, 263, 265 and AV inputs 320, 321 . . . 322.

The number of AV inputs 320, 321 . . . 322 allows the media CODEC 100 to receive a number of uncompressed media streams from external AV sources such as a VCR, a camcorder or other CE appliances. Moreover, the media CODEC may digitize, pre-process, encode, multiplex, index, encrypt and store (in the manner described above) multiple media streams which are received from the external AV sources, in accordance with one or more AV compression algorithms. Moreover, as described above, the media CODEC 100 is also used to digitize, pre-process, encode, multiplex, index, encrypt and store multiple media streams which are received from analog channels through tuners 260, 262 . . . 264 and receivers 261, 263 . . . 265. Preferably, the encoded media streams are encrypted according to an encryption algorithm or a conditional access algorithm and are transferred to the external HDD 117 for storage. Such an HDD 117 allows the user to use the STB as a personal video recorder (PVR) to record and store media and audio streams. Sequentially or simultaneously, such transport streams are preferably read from the external HDD 117 and are transferred to the media CODEC 100 which operates as described above to decrypt, de-multiplex, decode, post-process, blend and render for displaying one or more composite video and audio streams in either normal or trick play mode. As discussed above, composite streams include those which are several streams blended together or single streams blended with graphics planes and still images, or more than one stream blended together and to which blend is added graphics planes and/or still images.

Camcorder

It should be noted that the Media CODEC 100 may also be used in camcorders. In such an embodiment, the media CODEC 100 may be connected to the image and audio sensors of the camcorder in order to acquire their outputs directly. In such an embodiment, the Media CODEC 100 is used to pre-process, encode, multiplex, index and encrypt video and audio streams which are received from the sensors, and store the encrypted compressed media stream on the camcorder's storage media, which may be digital tape, HDD, DVD or flash memory card etc. In such an embodiment, the media CODEC 100 output is connected to the input of the camcorder storage. Preferably, the media CODEC 100 is used to read media streams being recorded in real-time, or previously recorded media streams from the camcorder's storage. Further, media CODEC 100 is used to decrypt, demultiplex, decode, post-process, blend and render for display the one or more composite video and audio streams in either continuous playback mode, trick play mode or preview mode. In such an embodiment, the media CODEC 100 output is connected to the Audio/Video output ports of the camcorder (such as S-Video, Composite, Component, HDMI etc.), and to its display devices. The media CODEC 100 may transfer the compressed, preferably encrypted, media streams to the HDD, USB, IEEE1394(FireWire) and the like outputs, for storage, display and further use.

DTV

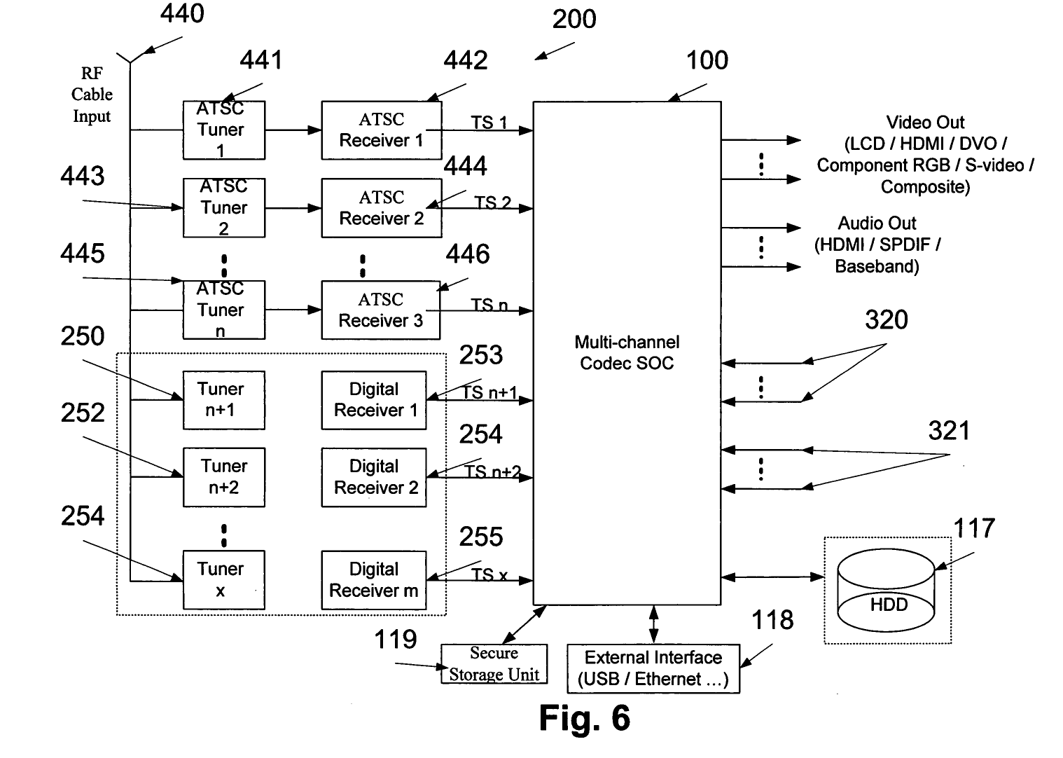

Reference is now made to FIG. 6, which is a digital TV, preferably defined according to advanced television systems committee (ATSC) standards, and comprises optional digital cable support, which is preferably defined according to open cable application platform (OCAP) standards. Preferably, the digital TV comprises an optional embedded personal video recorder 200. The media CODEC 100, the secure storage unit 119, the external interface 118, and the HDD 117, the sets of tuners 250, 252, . . . , 254, and the demodulators/receivers 251, 253, . . . , 255 and the AV inputs 320, 321, . . . , 322 are as shown in FIG. 5 above. However, FIG. 6 further depicts digital terrestrial, preferably US ATSC tuners 441, 443 . . . 445 and receivers 442, 444 . . . 446. In the depicted design, the digital terrestrial signal is received through the RF input 440 and is transferred to an array of n ATSC tuners 441, 443 . . . 445. Each one of the tuners is tuned to a different program channel. Each one of the array of n ATSC tuners 441, 443 . . . 445 is connected to a corresponding ATSC receiver 442, 444 . . . 446. Each one of the receivers 442, 444 . . . 446 generates a digitized transport stream that is transferred to the transport stream input 123 of the media CODEC 100. The digitized transport streams are preferably (a) transcoded as described above and stored for future use or (b) re-encrypted and indexed for future use, or (c) indexed, decrypted, de-multiplexed, decoded, postprocessed, blended and displayed. As in FIG. 5, in the embodiment depicted in FIG. 6, a number of AV inputs 320, 321 . . . 323 are used. The AV inputs may support conventional video connections such as an HDMI connection, DVI connection, Component/RGB connection, S-video connection, composite connection or a combination thereof. The AV inputs may also support regular audio connections such as HDMI with HDCP connection, Sony/Philips Digital Interface Format (S/PDIF) connection, baseband audio connection, etc.

General Use

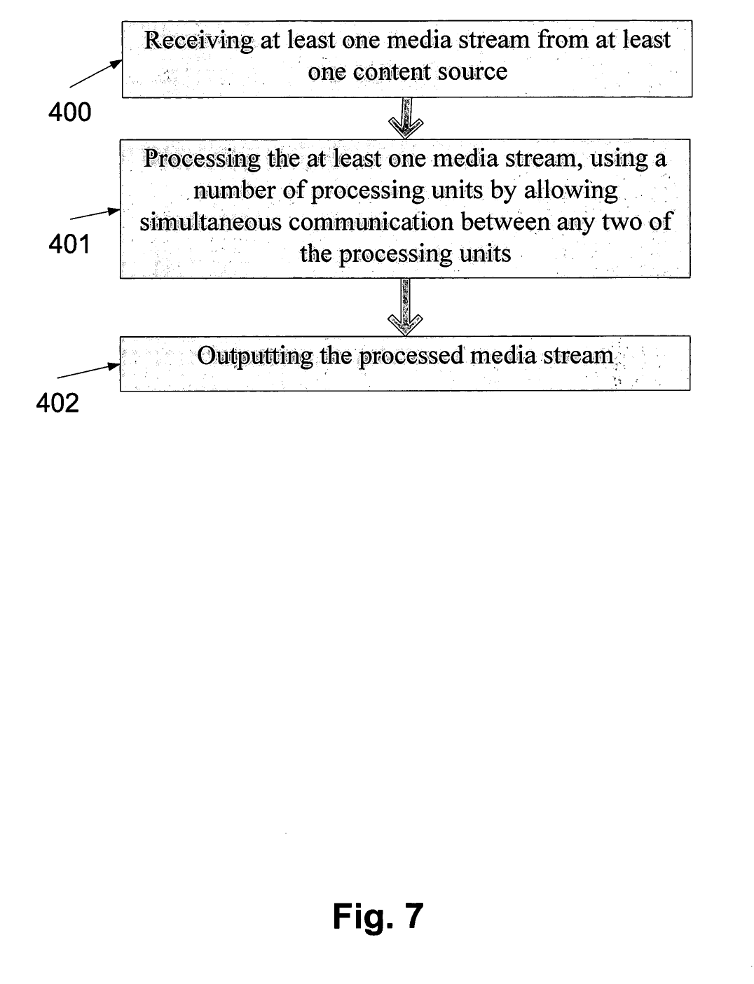

Reference is now made to FIG. 7, which is a flowchart of an exemplary method for processing one or more media streams, according to a preferred embodiment of the present invention. During the first step, as shown at 400, one or more analog or digital media streams, which are either compressed or uncompressed, are received from one or more content sources. The data streams are preferably received at a STB that comprises the media CODEC or at a CE appliance that is connected to such a STB, such as a HD-DVD, a Blu-Ray player, a personal video recorder, a place-shifting TV, and a digital TV.

The media CODEC allows the execution of one or more of the following operations in parallel on one or more of the received media streams, as shown at 401:

(a) Decrypting, indexing, de-multiplexing, decoding, post-processing and blending;

(b) Preprocessing, encoding, multiplexing, indexing and encrypting;

(c) Transcoding the media data streams; and

(d) Executing a plurality of real-time operating system tasks;

As shown at 402, the processed media streams, which are now either compressed or uncompressed and represented in digital or analog form, are output to storage, to transmission or to a display or sound device. Such architecture allows a number of storage, transmission or display devices to receive the processed media stream or derivative thereof, and allows a number of users to simultaneously access different media channels.

### Additional Exemplary Embodiments

The following is a list of three exemplary embodiments of the present invention. It will be noted that different embodiments include different combinations of features and the following is not by any means an exhaustive list.

As a first example, a possible decoder only implementation may incorporate just the following features:
AV Preprocessor 101
Decoder only (reduced) version of Video EnDec 102
Decoder only (reduced) version of the Entropy CODEC 103
Demultiplexer only (reduced) version of the Data Multiplexer/Demultiplexer 104
Decryption only (reduced) version of the Data Encryption/Decryption 105
Decoder only (reduced) version of the Audio ENDEC Processor 106
Decoder only (reduced) version of the Still Image EnDec 108
CPU 109
Secure Peripheral Module 110
2D/3D Graphics Engine/Blender 111
AV Postprocessor 123
Secure AV Digital/Analog output module 114
Central Switch 115
Secure Memory Controller 116

An encoder only implementation may incorporate just the following features:
AV Preprocessor 101
Encoder only (reduced) version of Video EnDec 102
Encoder only (reduced) version of the Entropy CODEC 103
Multiplexer only (reduced) version of the Data Multiplexer/Demultiplexer 104
Encryption only (reduced) version of the Data Encryption/Decryption 105
Encoder only (reduced) version of the Audio ENDEC Processor 106
Motion Estimation Processor 107
Encoder only (reduced) version of the Still Image EnDec 108
Secure Peripheral Module 110
RDO Processor 113
Central Switch 115
Secure Memory Controller 116

Thirdly, an A PC graphics chip may incorporate just the following features:
2D/3D Graphics Engine/Blender 111
Secure Peripheral Module 110
Secure AV Digital/Analog Output Module 114
Central Switch 115
Secure Memory Controller 116

The person skilled in the art may realize the Media CODEC 100 as installed in any kind of electronic device associated with media processing, hereinafter a media-handling device, including a camcorder, Digital Versatile Disk (DVD) player or recorder, High Definition DVD (HD-DVD) player or recorder, BluRay player or recorder, cellular telephones, portable electronic devices of various kinds including portable TV receivers, portable video players, portable audio players, video conferencing equipment, broadcast equipment, video surveillance equipment, cable/satellite/terrestrial set-top boxes and home media gateways, Internet Protocol TV (IPTV) terminals & equipment, PCs, workstations and servers, consumer electronic devices and PC appliances, personal video recorders, play-shift TV, wireless TV, 2-piece TV and the like.

It is expected that during the life of this patent many relevant devices and systems will be developed and the scope of the terms herein, particularly of the terms media CODEC, ENDEC, stream, communication, and home gateway are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An integrated circuit for processing a media stream, comprising:
an input interface configured for receiving said media stream from a content source;
a plurality of processing units;
a switch, electronically connected to said input interface and directly connected to each said processing unit, said switch configured for allowing two said processing units to simultaneously receive said media stream, thereby allowing simultaneous processing of said media stream by said processing units; and
an output interface, operatively connected to said switch, configured for outputting said simultaneously processed media stream.

2. The integrated circuit of claim 1, wherein said integrated circuit comprises a secured memory interface configured for encrypting data transfer to and from an external memory device.

3. The integrated circuit of claim 1, wherein said integrated circuit comprises a secured memory interface configured for operating, encryption, and decryption of the entire information flow to and from an external memory device.

4. The integrated circuit of claim 2, wherein said encrypting is carried out according to a DRM scheme, wherein DRM keys are generated using at least one of the group comprising a pseudo-random number generator and a true random number generator, or said keys are stored in one member of the group comprising: a secure embedded one-time programmable memory, a software application, and an external device.

5. The integrated circuit of claim 2, wherein said encrypting is carried out according to a plurality of secure DRM keys.

6. The integrated circuit of claim 1, wherein said input interface comprises at least one member of the group consisting of: an Ethernet connection, a universal serial bus (USB) connection, a ieee1394 (Firewire) connection, a standard product interface (SPI), a serial signal interface (SSI), an advanced technology attachment (ATA) drive, an ATA packet interface (ATAPI) drive, integrated drive electronics (IDE) drive, a serial ATA (SATA) drive, and a general purpose input/output (GPIO).

7. The integrated circuit of claim 1, wherein said plurality of processing units are configured to receive said media stream from said input interface via said switch.

8. The integrated circuit of claim 2, wherein said switch is coupled with a secured memory interface comprising a storage device.

9. The integrated circuit of claim 8, wherein one of said plurality of processing units comprises an embedded central processing unit (CPU) that comprises a secure boot loader module.

10. The integrated circuit of claim 1, wherein said plurality of processing units are configured for simultaneously processing said media stream according to at least two of the members of the group consisting of: encoding, pre-processing, de-interlacing, decoding, post-processing, transcoding, blending, encrypting, and decrypting.

11. The integrated circuit of claim 1, wherein at least one of said plurality of processing units comprises a security element.

12. The integrated circuit of claim 1, wherein said switch is configured for allowing each one of said plurality of processing units to communicate with another of said plurality of processing units.

13. The integrated circuit of claim 1, wherein said media stream comprises a member of a group consisting of: an audio stream, a video stream, a still image, a graphical object, and a text section.

14. The integrated circuit of claim 1, wherein said input interface is configured for receiving a plurality of media streams.

15. The integrated circuit of claim 1, wherein said switch having structure and capacity to allow two or more of said processing units to simultaneously receive at least two different media streams from different processing units.

16. The integrated circuit of claim 1, wherein at least one of said plurality of processing units is configured for generating a composite video stream according to said media stream.

17. The integrated circuit of claim 1, wherein at least one of said plurality of processing units is configured to compress said media stream according to a compression algorithm.

18. The integrated circuit of claim 17, wherein said compression algorithm is a member of a group consisting of: an MPEG1 compression algorithm, an MPEG2 compression algorithm, an MPEG4 compression algorithm, an audio visual component (AVC) compression algorithm, a society of motion picture and television engineers (VC-1) compression algorithm, an audio video subsystem (AVS) compression algorithm, and an H.263 compression algorithm.

19. The integrated circuit of claim 1, wherein at least one of said plurality of processing units is configured to decompress said media stream according to a decompression algorithm.

20. The integrated circuit of claim 12, wherein at least one of said plurality of processing units is configured for preprocessing said media stream before it is compressed.

21. The integrated circuit of claim 20, wherein said preprocessing comprises implementing a member of a group consisting of: decreasing scaling, spatial filtering, temporal filtering, linear filtering, non-linear filtering, and reducing noise of said media stream.

22. The integrated circuit of claim 12, wherein at least one of said plurality of processing units is a rate distortion optimization (RDO) processor, said RDO processor configured to choose said compression algorithm.

23. The integrated circuit of claim 12, wherein at least one of said plurality of processing units is configured to obtain a prediction of rate distortion based upon said media stream and to select a number of compression parameters to minimize the rate distortion of said media stream.

24. The integrated circuit of claim 1, wherein at least one of said plurality of processing units is configured to multiplex said media stream.

25. The integrated circuit of claim 1, wherein at least one of said plurality of processing units is configured to demultiplex said media stream.

26. The integrated circuit of claim 1, wherein at least one of said plurality of processing units is configured to generate at least one layer of graphical objects, said composite video stream combines said at least one layer of graphical objects.

27. The integrated circuit of claim 1, said switch having an external device connection, said switch being configured to receive an additional media stream via said external device connection.

28. The integrated circuit of claim 27, wherein said external device connection is connected to a member of a group consisting of: a hard disk drive (HDD), a secure memory device, and a client equipment (CE) appliance.

29. The integrated circuit of claim 28, said member being connected to said external device connection via secure peripheral equipment.

30. The integrated circuit of claim 27, at least one of said plurality of processing units being configured for processing said additional media stream.

31. The integrated circuit of claim 30, said processing comprising blending said additional media stream with said media stream.

32. The integrated circuit of claim 1, wherein said switch is configured for allowing simultaneous communication between two or more of said plurality of processing units and another of said processing units.

33. The integrated circuit of claim 30, wherein said switch is configured for allowing said simultaneous communication by time division multiplexing outputs of said two or more of said plurality of processing units.

34. The integrated circuit of claim 1, wherein one of said processing units is a memory device.

35. The integrated circuit of claim 1, at least one of said plurality of processing units being configured for encrypting said media stream.

36. The integrated circuit of claim 1, at least one of said plurality of processing units being configured for decrypting said media stream.

37. The integrated circuit of claim 1, at least one of said plurality of processing units being configured for postprocessing said media stream, said postprocessing comprising implementing a member of a group consisting of: image processing frames from said media stream, increasing the scaling of frames from said media stream, decreasing the scaling of frames from said media stream, enhancing the values of frames from said media stream, converting the color values of frames from said media stream, enhancing the edge of frames from said media stream, reducing noise from said media stream, deblocking said media stream, deringing said media stream, and deinterlacing said media stream.

38. The integrated circuit of claim 1, wherein said plurality of processing units comprises a member of a group consisting of: an audio/video (AV) preprocessor, an encoding/decoding (ENDEC) processor, an entropy CODEC, a data multiplexor/demultiplexor, a data encryption/decryption processor, an audio ENDEC processor, a motion estimation processor, a still image ENDEC processor, an embedded CPU, a 2D/3D graphics engine/blender, an AV postprocessor, and a rate distortion optimization (RDO) processor.

39. The integrated circuit of claim 1, wherein said output interface is configured for adding a protection tag onto said media stream.

40. The integrated circuit of claim 1, wherein at least one of said plurality of processing units is configured to transcode said media stream according to a predefined algorithm.

41. The integrated circuit of claim 1, configured for integration into a media-handling device.

42. A method for providing a media stream, comprising:
a) receiving said media stream from a content source;
b) simultaneously providing said media stream to a plurality of processing units by allowing communication between any two of said plurality of processing units; and
c) outputting said simultaneously processed media stream.

43. The method of claim 42, wherein each one of said plurality of processing units is configured to communicate with another of said plurality of processing units via a switch having the capacity and configuration to handle a plurality of media streams simultaneously.

44. The method of claim 42, wherein said step of receiving comprises a step of receiving a plurality of media streams from at least one content source.

45. The method of claim 42, wherein said step of simultaneously providing comprises a step of simultaneously providing said plurality of media streams.

46. The method of claim 45, further comprising a step between steps (b) and (c) of generating a composite video stream according to at least two of said plurality of media streams.

47. The method of claim 42, further comprising a step between steps (b) and (c) of compressing said media stream according to a compression algorithm.

48. The method of claim 42, further comprising a step between steps (b) and (c) of decompressing said media stream according to a decompression algorithm.

49. The method of claim 42 further comprising a step between steps (b) and (c) of preprocessing said media stream using at least one of said plurality of processing units.

50. The method of claim 48, wherein said preprocessing comprises a step of a group consisting of: decreasing scaling, spatial filtering, temporal filtering, linear filtering, nonlinear filtering, and reducing noise of said media stream.

51. The method of claim 42, further comprising a step between steps (b) and (c) of compressing said media stream using a compression algorithm.

52. The method of claim 42, further comprising a step between steps (b) and (c) of choosing said compression algorithm.

53. The method of claim 42, further comprising a step between steps (b) and (c) of multiplexing said media stream.

54. The method of claim 42, further comprising a step between steps (b) and (c) of demultiplexing said media stream.

55. The method of claim 42, further comprising a step between steps (b) and (c) of transcoding said media stream.

56. The method of claim 42, further comprising a step between steps (b) and (c) of:
generating at least one layer of graphical objects; and
combining said at least one layer of graphical objects with said media stream.

57. The method of claim 42, further comprising a step between steps (b) and (c) of:
receiving an additional media stream from an external device; and
combining said additional media stream with said media stream.

58. The method of claim 42, further comprising a step between steps (b) and (c) of:
generating a time multiplexed stream according to outputs of two or more of said plurality of processing units; and
transferring said time multiplexed stream to another of said plurality of processing units, thereby allowing said two or more of said plurality of processing units to simultaneously communicate with said other of said plurality of processing units.

59. The method of claim 42 further comprising a step between steps (b) and (c) of postprocessing said media stream using at least one of said plurality of processing units.

60. The method of claim 59, wherein said step of postprocessing comprises one member of the group consisting of: image processing frames from said media stream, increasing the scaling of frames from said media stream, decreasing the scaling of frames from said media stream, enhancing the values of frames from said media stream, converting the color values of frames from said media stream, enhancing the edges of frames from said media stream, reducing noise from said media stream, deblocking said media stream, deringing said media stream, and deinterlacing said media stream.

61. The method of claim 42 further comprising a step of adding a protection tag onto said media stream.

62. The method of claim 42 further comprising a step between steps (b) and (c) of decrypting said media stream using at least one of said plurality of processing units.

63. The method of claim 42 further comprising a step between steps (b) and (c) of encrypting said media stream using at least one of said plurality of processing units.

64. A home gateway for processing a media stream, comprising:
an input interface configured for receiving said media stream;
a plurality of tuners, electronically connected to said input interface, each one of said tuners being configured for a different channel of said media stream;
an encoding/decoding unit, electronically connected to said tuners, configured for simultaneously processing said different channels; and
an output interface, operatively connected to said encoding/decoding unit, configured for outputting said simultaneously processed different channels.

65. The home gateway of claim 64, wherein said encoding/decoding unit comprises a plurality of processing units, said encoding/decoding unit being configured to perform said processing by allowing communication between any two of said plurality of processing units.

66. The home gateway of claim 64, wherein said input and output interfaces are connected to a storage device, wherein said storage device is configured to receive said processed different channels and to transmit said media stream respectively via said output and input interfaces.

67. The home gateway of claim 64, wherein said processing comprises a member of the following group: de-multiplexing, decrypting, decoding, indexing, transcoding post-processing, blending, storing, and rendering.

68. The home gateway of claim 64, wherein said encoding/decoding unit is configured to transcode said media stream from a first resolution to a second resolution, said second resolution being different from said first resolution.

69. A camcorder having a processing unit for processing a captured media stream, said camcorder comprising:
at least one image sensor for capturing a sequence of images and generating a media stream based thereupon;
a plurality of processing units;
a switch, electronically connected to said at least one image sensor and directly connected to each said processing unit, said switch configured for allowing two said processing units to simultaneously receive said media stream, thereby allowing simultaneous processing of said media stream by said processing units; and
an output interface, operatively connected to said switch, configured for outputting said simultaneously processed media stream.

70. The camcorder of claim 69, wherein said processing comprises a member of the group consisting of at least two of the following actions: encoding, decoding, multiplexing, demultiplexing, indexing, pre processing, post processing, and blending.

71. The camcorder of claim 69, further comprises an external media streams input electronically connected to said switch, said external media streams configured for receiving a additional media stream, said switch configured for allowing two said processing units to simultaneously receive said additional media stream.

72. The camcorder of claim 69, wherein said output interface is connected to at least one member of the following group: an integrated display screen, a storage device, an external display screen, and a communication interface.

73. A digital television having an encoding/decoding unit, said digital television comprising:
a display unit;
a personal video recorder unit configured for generating a first media stream;
an input interface configured for receiving a second media stream;
a plurality of tuners, electronically connected to said input interface, each one of said tuners being configured for a different channel of said second media stream; and
an encoding/decoding unit, electronically connected to said tuners and to said personal video recorder, configured for simultaneously processing said different channels and said first and second media streams for outputting said simultaneously processed different channels to said display unit.

74. The digital television of claim 73, wherein said personal video recorder is configured to store said simultaneously processed different channels.

75. The digital television of claim 73, wherein said encoding/decoding unit is configured for simultaneously processing said different channels by blending with still images

76. The digital television of claim 73, wherein said encoding/decoding unit is configured for simultaneously processing said different channels with at least one graphic plane stored in said personal video recorder unit.

77. The digital television of claim 73, wherein said encoding/decoding unit is configured to generate a composite stream based upon at least two of said simultaneously processed different channels.

78. The digital television of claim 73, wherein said encoding/decoding unit is configured for decoding said first and second media streams and which television is further configured to store said decoded media streams in said personal video recorder.

79. A method for enabling a media stream for use with video transport controls, the method comprising:
a) receiving said media stream from a content source;
b) tagging frames of said media stream, each said frame being tagged according to its characteristics;
c) receiving a command for a given transport control;
d) selecting frames according to corresponding tags, said selecting being determined by the given transport control; and
e) playing said selected frames.

80. The method of claim 79, wherein said selecting comprises selecting frames sharing a common tag.

81. The method of claim 79, wherein said transport controls comprise a member of the following group: instant replay, rewind, fast forward, and fast backward.

82. The method of claim 79, wherein said characteristics comprise a member of the following group: frame type, frame encoding type, a frame number, a depicted object, and a feature-set.

83. The method of claim 79, further comprising a stage between a) and b) of evaluating the motion of various video objects depicted in said media stream, wherein said tagging is based on said evaluation.

84. The method of claim 83, wherein said evaluation comprises detecting at least one of the following group: a substantial movement and a sudden scene change.
